(19) United States
(12) Patent Application Publication
(10) Pub. No.: US 2023/0223196 A1
(43) Pub. Date: Jul. 13, 2023

(54) MULTILAYER CERAMIC ELECTRONIC DEVICE AND MANUFACTURING METHOD OF THE SAME

(71) Applicant: TAIYO YUDEN CO., LTD., Tokyo (JP)

(72) Inventor: Koichiro MORITA, Tokyo (JP)

(73) Assignee: TAIYO YUDEN CO., LTD., Tokyo (JP)

(21) Appl. No.: 18/079,315

(22) Filed: Dec. 12, 2022

(30) Foreign Application Priority Data
Jan. 12, 2022 (JP) 2022-003034

(51) Int. Cl. H01G 4/232; H01G 4/30; H01G 4/248; H01G 4/12

(52) U.S. Cl. CPC H01G 4/2325; H01G 4/30; H01G 4/248; H01G 4/1227

(57) ABSTRACT

A multilayer ceramic electronic device includes a multilayer chip having a plurality of internal electrode layers that face each other and a plurality of dielectric layers, each of which is sandwiched by two of the plurality of internal electrode layers, one end of at least one of the plurality of internal electrode layers being exposed at a side face of the multilayer chip, a first external electrode that is provided on the side face of the multilayer chip, is in contact with at least one of the each end of the plurality of internal electrode layers, and includes ceramic grains, and a second external electrode that is provided on the first external electrode, has a glass, and has a main component that is a same metal as that of the first external electrode.

### FIELD

A certain aspect of the present disclosure relates to a multilayer ceramic electronic device and a manufacturing method of the multilayer ceramic electronic device.

### BACKGROUND

Multilayer ceramic electronic devices are used in high-frequency communication systems typified by mobile phones. For example, multilayer ceramic capacitors are used to remove noise (see Patent Documents 1 to 4, for example). Metals such as Ag, Ni, and Cu or conductive resins are generally used for external electrodes of multilayer ceramic electronic devices. Among them, Ni and Cu are widely used, and these are generally plated with Cu, Ni, or Sn. The metals have many advantages such as resistance to reduction (the Ni internal electrode works as an external electrode in an atmosphere where the Ni internal electrode does not oxidize), resistance to ion migration, ensuring good contact with the internal electrode, lower equivalent series resistance (ESR), and low price.

### PRIOR ART

### Patent Document

Document 1: Japanese Patent Application Publication No. 2018-098327
Document 2: Japanese Patent Application Re-Publication No. 2018-014407
Document 3: Japanese Patent Application Re-Publication No. 2019-195037
Document 4: Japanese Patent Application Publication No. 2020-155719

### SUMMARY OF THE INVENTION

There are two types of external electrodes: those that are formed afterward and those that are formed by simultaneous firing. The post-attached external electrodes are formed by applying with a metal paste and baking the metal paste after firing the body. The co-fired external electrodes are those in which a metal paste is applied to an unfired ceramic body and the ceramic body and the metal paste are fired at the same time. In any of these types, cracks may occur in the ceramic body.

The present invention has a purpose of providing a multilayer ceramic electronic device capable of suppressing cracks and a manufacturing method of the multilayer ceramic electronic device.

According to a first aspect of the embodiments, there is provided a multilayer ceramic electronic device including: a multilayer chip having a plurality of internal electrode layers that face each other and a plurality of dielectric layers, each of which is sandwiched by two of the plurality of internal electrode layers, one end of at least one of the plurality of internal electrode layers being exposed at a side face of the multilayer chip, the side face being an end of the multilayer chip in a direction in which the plurality of internal electrode layers extend; a first external electrode that is provided on the side face of the multilayer chip, is in contact with the exposed one end of the at least one of the plurality of internal electrode layers, and includes ceramic grains; and a second external electrode that is provided on the first external electrode, has a glass, and has a main component that is a same metal as that of the first external electrode.

The second external electrode may be in contact with a main face of the multilayer chip and a corner portion of the multilayer chip, the main face being an end of the multilayer chip in a direction in which the plurality of dielectric layers and the plurality of internal electrode layers are stacked.

The plurality of internal electrode layers may have a main component that is a same metal as that of the first external electrode.

The first external electrode and the second external electrode may be in direct contact with each other.

Each of the ceramic grains may be a metal oxide.

A main component of the plurality of internal electrode layers, the first external electrode, and the second external electrode may be nickel. And each of the ceramic grains may contain at least one of aluminum oxide or barium titanate.

A main component of the plurality of internal electrode layers, the first external electrode, and the second external electrode may be copper. And each of the ceramic grains may contain at least one of aluminum oxide or calcium zirconate.

In the direction in which the plurality of internal electrode layers extend, a thickness of the first external electrode may be 5 μm or less.

The ceramic grains may be contained in an amount of 5 wt % or more and 20 wt % or less with respect to the first external electrode.

The multilayer ceramic electronic device may further include a plated layer on the second external electrode layer.

According to a second aspect of the embodiments, there is provided a multilayer ceramic electronic device including; a multilayer chip having a plurality of internal electrode layers that face each other and a plurality of dielectric layers, each of which is sandwiched by two of the plurality of internal electrode layers, one end of at least one of the plurality of internal electrode layers being exposed at a side face of the multilayer chip, the side face being an end of the multilayer chip in a direction in which the plurality of internal electrode layers extend; and an external electrode having a first section and a second section, wherein the first section is provided on the side face of the multilayer chip, is in contact with the exposed one end of the at least one of the plurality of internal electrode layers, and includes ceramic grains, wherein a second section covers the first section and includes glass, wherein an amount of the ceramic grains of the first section is larger than that of the second section, and wherein an amount of the glass of the second section is larger than that of the first section.

The second section may be in contact with a main face of the multilayer chip and a corner portion of the multilayer chip, the main face being end of the multilayer chip in a direction in which the plurality of dielectric layers and the plurality of internal electrode layers are stacked.

The plurality of internal electrode layers may have a main component that is a same metal as that of the external electrode.

Each of the ceramic grains may be a metal oxide.

A main component of the plurality of internal electrode layers and the external electrode may be nickel. And each of the ceramic grains may contain at least one of aluminum oxide or barium titanate.

A main component of the plurality of internal electrode layers and external electrode may be copper. And each of the ceramic grains may contain at least one of aluminum oxide or calcium zirconate.

The multilayer ceramic electronic device may further include: a plated layer on the external electrode layer.

According to a third aspect of the embodiments, there is provided a manufacturing method of a multilayer ceramic electronic device including: forming a plurality of ceramic green sheets; forming an internal electrode pattern of a conductive paste on at least some of the plurality of ceramic green sheets; thereafter forming an unfired multilayer chip by stacking the plurality of the green sheets, forming a metal paste including ceramic grains on a side face of the unfired multilayer chip; forming a first external electrode from the metal paste by firing the unfired multilayer chip and the metal paste; and forming a second external electrode containing glass so as to cover the first external electrode after the firing.

The method may further include forming a plated layer on the second external electrode.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a partial cross-sectional perspective view of a multilayer ceramic capacitor;

FIG. 2 is a cross-sectional view taken along line A-A in FIG. 1;

FIG. 3 is a cross-sectional view taken along line B-B in FIG. 1;

FIG. 4A and FIG. 4B illustrate an external electrode formed later;

FIG. 5 illustrates a co-fired external electrode;

FIG. 6 illustrates an enlarged cross section of an external electrode;

FIG. 7 is a flowchart of a manufacturing method of a multilayer ceramic capacitor of a first embodiment;

FIG. 8A and FIG. 8B illustrate a stacking process of a first embodiment;

FIG. 9A illustrates a painting process; and

FIG. 9B illustrates a baking process.

### DETAILED DESCRIPTION

Hereinafter, an exemplary embodiment will be described with reference to the accompanying drawings.

### Exemplary Embodiments

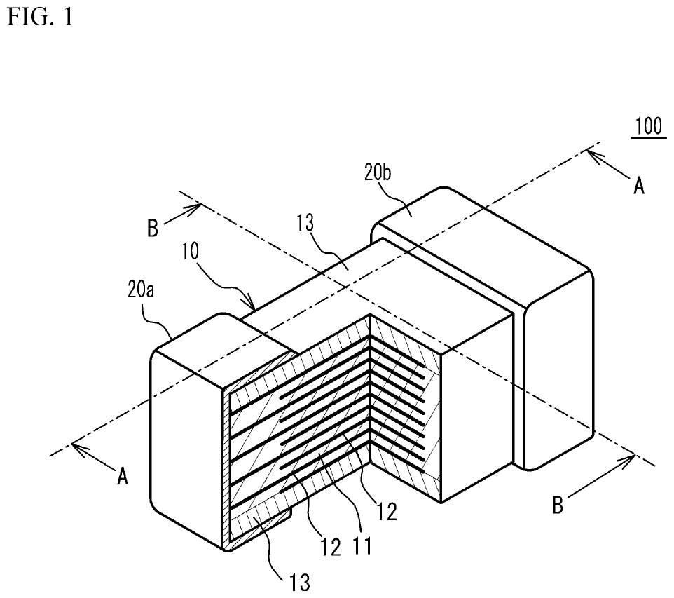

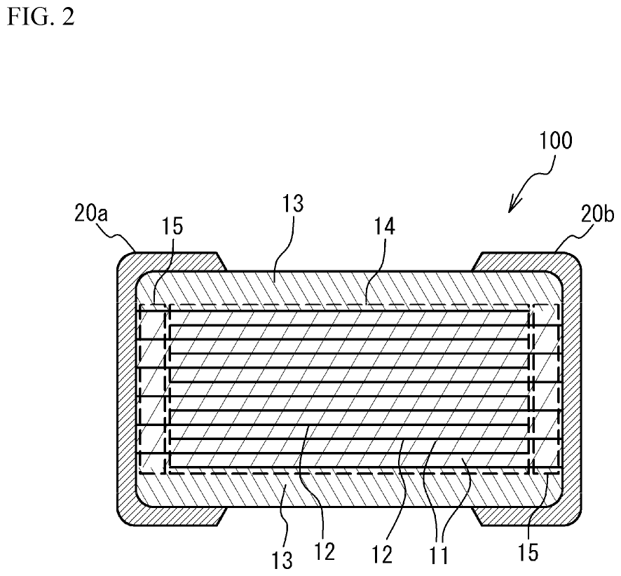

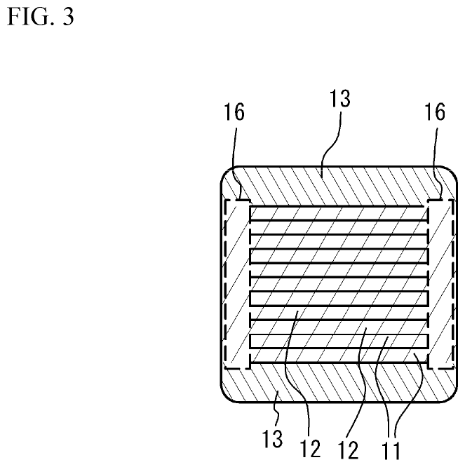

FIG. 1 illustrates a perspective view of a multilayer ceramic capacitor 100 in accordance with an embodiment, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes a multilayer chip 10 having a rectangular parallelepiped shape, and external electrodes 20a and 20b that are respectively provided on two end faces of the multilayer chip 10 opposite to each other. Among four faces other than the two end faces of the multilayer chip 10, two faces other than the top face and the bottom face in the stack direction are referred to as side faces. Each of the external electrodes 20a and 20b extends to the top face and the bottom face in the stack direction and the two side faces of the multilayer chip 10. However, the external electrodes 20a and 20b are spaced from each other.

The multilayer chip 10 has a structure in which dielectric layers 11 containing a ceramic material acting as a dielectric and internal electrode layers 12 mainly composed of metal are alternately stacked. In other words, the multilayer chip 10 includes the internal electrode layers 12 facing each other and the dielectric layers 11 sandwiched between the internal electrode layers 12. The edges in the direction in which each internal electrode layer 12 extends are alternately exposed at a first end face provided with the external electrode 20a of the multilayer chip 10 and a second end face provided with the external electrode 20b. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 is the same as the main component of the dielectric layer 11.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 1.0 mm, a width of 0.5 mm, and a height of 0.1 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

A main component of the dielectric layer 11 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr_{z}O₃ (0≤x≤1, 0≤y≤1, 0≤z≤1) having a perovskite structure. Ba_{1-x-y}CaₓSr_{y}Ti_{1-z}Zr_{z}O₃ may be barium strontium titanate, barium calcium titanate, barium zirconate, barium titanate zirconate, calcium titanate zirconate, barium calcium titanate zirconate or the like.

Additives may be added to the dielectric layer 11. As additives to the dielectric layer 11, an oxide of magnesium (Mg), manganese (Mn), molybdenum (Mo), vanadium (V), chromium (Cr), or a rare earth element (yttrium (Y), samarium (Sm), europium (Eu), gadolinium (Gd), terbium (Tb), dysprosium (Dy), holmium (Ho), erbium (Er), thulium (Tm) and ytterbium (Yb), or an oxide of cobalt (Co), nickel (Ni), lithium (Li), boron (B), sodium (Na), potassium (K) or silicon (Si), or a glass including cobalt, nickel, lithium, boron, sodium, potassium or silicon.

The internal electrode layer 12 is mainly composed of a base metal such as nickel (Ni), copper (Cu), or tin (Sn). The internal electrode layer 12 may be composed of a noble metal such as platinum (Pt), palladium (Pd), silver (Ag), or gold (Au) or alloy including one or more of them.

As illustrated in FIG. 2, the section where the internal electrode layer 12 connected to the external electrode 20a faces the internal electrode layer 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin section 15. The section where the internal electrode layers 12 connected to the external electrode 20b face each other with no internal electrode layer 12 connected to the external electrode 20a interposed therebetween is another end margin section 15. That is, the end margin section 15 is a section where the internal electrode layers 12 connected to one of the external electrodes face each other with no internal electrode layer 12 connected to the other of the external electrodes interposed therebetween. The end margin section 15 is a section where no capacity is generated.

As illustrated in FIG. 3, in the multilayer chip 10, a section from one of the two side faces of the multilayer chip 10 to lateral side edges of the internal electrode layers 12 is referred to as a side margin section 16. That is, each of the side margin sections 16 is a section that covers the lateral side edges, extending toward one of the side faces of the multilayer structure, of the stacked internal electrode layers 12. The side margin section 16 is a section where no capacity is generated.

A description will be given of the external electrodes. First, a description will be given of an external electrode to be formed later. The external electrode is formed by firing an unfired body in which a plurality of stack units each having an internal electrode pattern for the internal electrode layer 12 printed on a ceramic green sheet for the dielectric layer 11 are stacked, baking a based layer on the fired body, and forming a plated layer on the base layer.

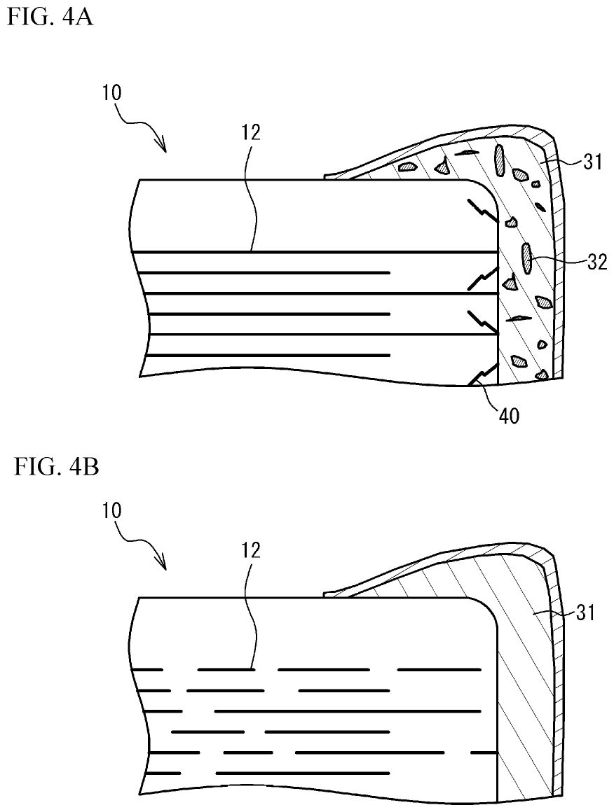

FIGS. 4A and 4B are diagrams for explaining external electrodes to be formed later. In FIG. 4A and FIG. 4B, hatching of the multilayer chip 10 is omitted. As exemplified in FIG. 4A, a base layer 31 is baked on the multilayer chip 10 after firing, by heat-treating the metal paste. A low-melting-point glass 32 is added to the metal paste in order to lower the temperature of the heat treatment for the baking. Since the fired multilayer chip 10 has a high strength, it is possible to suppress the occurrence of cracks or the like when the base layer 31 is baked. However, the glass 32 may react with the multilayer chip 10 and cracks 40 may occur in the joints of the base layer 31.

Further, when the multilayer chip 10 is fired, the lead portions of the internal electrode layers 12 may be retracted into the multilayer chip 10 due to shrinkage during the sintering process. In this case, electrical contact between the base layer 31 and the internal electrode layer 12 may not be necessarily obtained. Therefore, it is conceivable to expose the lead portions of the internal electrode layers 12 by polishing the surface of the multilayer chip 10. However, the process is complicated and cost may increase. Moreover, there is a possibility that mechanical damage may remain.

When it is decided not to use the glass 32, it is necessary to heat the baking at a high temperature. In this case, the lead portions of the internal electrode layers 12 may be retracted into the interior of the multilayer chip 10. And, as illustrated in FIG. 4B, spheroidization at each position of the internal electrode layer 12 progresses, and there is a risk that the continuity modulus of the internal electrode layer 12 decreases.

Further, when the multilayer chip 10 is fired, the outermost surface of the lead portion of the internal electrode layer 12 may be oxidized by a small amount of oxygen in the furnace, and electrical contact between the base layer 31 and the internal electrode layer 12 may not be necessarily obtained.

Next, a description will be given of a co-fired external electrode. The co-fired external electrode is obtained by applying a metal paste for a base layer to an unfired multilayer chip in which a plurality of stack units each having an internal electrode pattern for the internal electrode layer 12 printed on the ceramic green sheet for the dielectric layer 11 are stacked, simultaneously firing the unfired multilayer chip and the metal paste, and forming a plated layer after the firing.

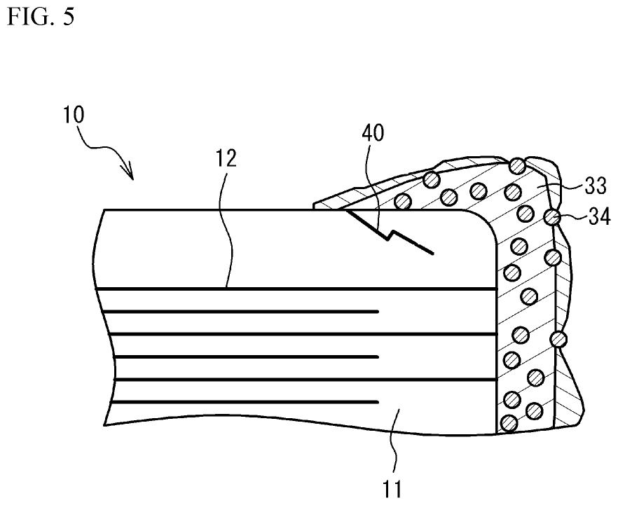

FIG. 5 is a diagram for explaining the co-fired external electrodes. In FIG. 5, hatching of the multilayer chip 10 is omitted. The cracks 40 may occur at the joints of a base layer 33 due to the mismatch between the shrinkage of the multilayer chip and the shrinkage of the base layer 33 during firing. Therefore, a method is adopted in which a co-material 34 (ceramic grains) such as metal oxide powder is added to the metal paste to delay the shrinkage of the metal paste. However, since the base layer 33 is required to have a predetermined thickness, the cracks 40 may still occur due to the mismatch between the shrinkage of the multilayer chip and the shrinkage of the base layer 33 during firing.

Also, although the electrical contact between the base layer 33 and the internal electrode layer 12 is ensured, the co-material 34 (ceramic grains) is exposed on the outer surface of the base layer 33 as illustrated in FIG. In this case, plating may not be necessarily applied, resulting in poor plating.

Therefore, the external electrodes 20a and 20b according to the present embodiment have a configuration capable of suppressing the occurrence of the cracks. In addition, the external electrodes 20a and 20b according to the present embodiment can ensure electrical contact with the internal electrode layers 12, can suppress a decrease in the continuity modulus of the internal electrode layers 12, and can suppress plating defects.

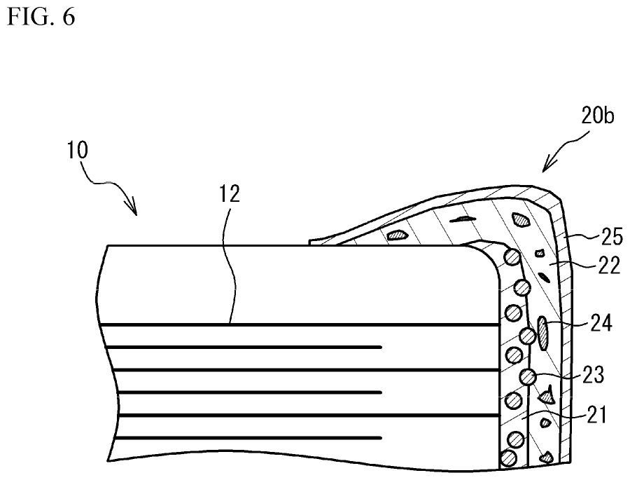

FIG. 6 is an enlarged cross-sectional view of the external electrode 20b. In FIG. 6, hatching of the multilayer chip 10 is omitted. As illustrated in FIG. 6, the external electrode 20b has a structure in which a second external electrode 22 is provided on a first external electrode 21. The first external electrode 21 includes a co-material 23. The second external electrode 22 contains a glass 24. The main components of the first external electrode 21 and the second external electrode 22 are common. A plated layer 25 is provided on the second external electrode 22.

Since the first external electrode 21 contains the co-material 23, the first external electrode 21 is formed by firing together with the multilayer chip 10. Since the second external electrode 22 contains the glass 24, the second external electrode 22 is formed by baking after the multilayer chip 10 is fired.

In the process of simultaneously firing the multilayer chip 10 and the first external electrodes 21, since the second external electrode 22 will be formed, it is not necessary to form the first external electrode 21 thick. Therefore, the stress during simultaneous firing of the first external electrode 21 is relieved, and the occurrence of cracks can be suppressed. Further, since the first external electrode 21 is arranged between the second external electrode 22 and the multilayer chip 10, the diffusion of the glass 24 into the multilayer chip 10 is suppressed. And the occurrence of the cracks is suppressed. Moreover, since the second external electrode 22 including the glass 24 can be baked at a low temperature (for example, about 800° C.), the occurrence of the cracks is suppressed. In addition, since the main component of the first external electrode 21 and the main component of the second external electrode 22 are the same metal, a strong bond can be obtained between the first external electrode 21 and the second external electrode 22. And, interfacial peeling is suppressed even if the stress is applied.

As described above, the external electrode 20b according to the present embodiment can suppress the occurrence of the cracks. Since the external electrode 20a also has a stacked structure similar to that of the external electrode 20b, the external electrode 20a can also be prevented from cracking.

In addition, since the internal electrode layer 12 and the first external electrode 21 are integrated, electrical contact failure caused by retraction of the lead portion of the internal electrode layer 12 is suppressed. In addition, since the second external electrode 22 can be baked at a relatively low temperature, a decrease in continuity modulus of the internal electrode layers 12 can be suppressed. In addition, since the first external electrode 21 is covered with the second external electrode 22, surface exposure of the co-material 23 is suppressed, and plating defects can be suppressed. Note that even if the glass 24 is exposed on the outer surface of the second external electrode 22, the glass phase exists as a very thin glass film in which the liquid phase that seeps out to the surface is solidified, unlike the co-material. The glass phase can be easily peeled off by general surface treatment (mechanical or chemical treatment).

Since the second external electrode 22 can be baked at a low temperature, the occurrence of cracks can be suppressed even if the second external electrode 22 is formed thick. Therefore, the thickness of the second external electrode 22 can be adjusted according to product specifications. The plating material and the number of layers formed on the second external electrode 22 can be freely set.

The second external electrode 22 preferably extends so as to be in contact with at least one of the upper surface, the lower surface and the two side surfaces of the multilayer chip 10 and corners (edges) of the multilayer chip 10. The corner portion is a portion having a curvature at a corner of the multilayer chip 10. In this configuration, the first external electrode 21 does not extend to the point where the second external electrode 22 contacts the multilayer chip 10. In this configuration, since the contact interface between the first external electrode 21 and the multilayer chip 10 becomes small, the occurrence of the cracks during simultaneous firing of the multilayer chip 10 and the first external electrode 21 can be suppressed.

It should be noted that since there is a high possibility that cracks will occur on the top face, the bottom face, and the two side faces of the multilayer chip 10 during simultaneous firing, crack generation can be effectively suppressed by not extending the first external electrodes 21 to these areas. In addition, for the external electrodes of the multilayer ceramic capacitor, the dimensions of the external electrodes extending to the top face, the bottom face, and the two side faces are sometimes determined by the product specifications due to the requirements for component mounting. In such a case, the second external electrode 22 should be extended.

The main component of the internal electrode layer 12 is preferably the same metal as the main component of the first external electrode 21. In this case, the alloying of the first external electrode 21 and the internal electrode layer 12 is suppressed, and the volume expansion of the internal electrode layer 12 inside the multilayer chip 10 is suppressed. Thereby, cracks due to volume expansion can be suppressed. For example, when the main component of the first external electrode 21 is nickel, the main component of the internal electrode layers 12 is also preferably nickel. When the main component of the first external electrode 21 is copper, it is preferable that the main component of the internal electrode layer 12 is also copper.

The second external electrode 22 is preferably provided on the first external electrode 21 in direct contact therewith. In this case, a stronger bond is obtained between the first external electrode 21 and the second external electrode 22, which are mainly composed of the same metal, and interfacial peeling is suppressed even when stress is applied.

Although the material of the co-material 23 (ceramic grains) is not particularly limited, it is preferable that the material is a metal oxide (ceramic) other than glass. In this case, the shrinkage of the first external electrodes 21 is delayed during co-firing, the difference in shrinkage between the multilayer chip 10 and the first external electrodes 21 is reduced, and the occurrence of cracks is suppressed. For example, as the co-material 23, the main component ceramic of the dielectric layer 11 can be used. In addition, as the co-material 23, barium titanate (BaTiO₃), aluminum oxide (Al₂O₃), zirconium oxide (ZrO₂), calcium oxide (CaO), magnesium oxide (MgO), calcium zirconate (CaZrO₃) or the like can be used.

When the main component of the internal electrode layer 12, the first external electrode 21, and the second external electrode 22 is nickel, the co-material 23 is preferably aluminum oxide or barium titanate. This is because when nickel is used for the internal electrode layer 12, the main phase of the dielectric layer 11 is generally barium titanate, and therefore, as the co-material, it is preferable to use a material that minimizes modification of the structure and electric characteristics of the dielectric layer 11 even if diffused into the dielectric layer 11.

When the main component of the internal electrode layer 12, the first external electrode 21, and the second external electrode 22 is copper, the co-material 23 is preferably aluminum oxide or calcium zirconate (CaZrO₃). This is because when copper is used for the internal electrode layer 12, the main phase of the dielectric layer 11 is generally calcium zirconate, and therefore, as the co-material, it is preferable to use a material that minimizes the modification of the structure and electrical characteristics of the dielectric layer 11 even if diffused into the dielectric layer 11.

In the direction in which the internal electrode layer 12 extends (the direction in which the external electrodes 20a and 20b face each other), the thickness of the first external electrode 21 is preferably 5 μm or less. In this case, the first external electrode 21 becomes thinner. And even if the multilayer chip 10 and the first external electrode 21 are co-fired at the same time, the stress caused by the difference in contraction between the multilayer chip 10 and the first external electrode 21 becomes small. It is therefore possible to suppress the occurrence of cracks. The thickness of the first external electrode 21 is more preferably 3 μm or less, and even more preferably 2 μm or less.

If the content of the co-material 23 in the first external electrode 21 is small, the stress caused by the difference in contraction between the multilayer chip 10 and the first external electrode 21 cannot be completely reduced, and cracks may occur. Therefore, it is preferable to set a lower limit for the content of the co-material 23 in the first external electrode 21. On the other hand, if the content of the co-material 23 in the first external electrode 21 is large, the bonding between the first external electrode 21 and the second external electrode 22 may be hindered, and the fixing strength may decrease. Therefore, it is preferable to set an upper limit for the content of the co-material 23 in the first external electrode 21. For example, the content of the co-material 23 in the first external electrode 21 is preferably 5 wt % or more and 20 wt % or less with respect to the entire first external electrode 21. In this case, the bonding strength between the first external electrode 21 and the second external electrode 22 increases by the anchor effect, and interfacial peeling is suppressed. The content of the co-material 23 in the first external electrode 21 is more preferably 7 wt % or more and 15 wt % or less, more preferably 10 wt % or more and 13 wt % or less, with respect to the entire first external electrode 21.

The material of the glass 24 in the second external electrode 22 is not particularly limited, but is selected according to the baking temperature of the second external electrode 22. For example, the material of the glass 24 is preferably glass having silicon oxide (SiO₂) as a framework and containing Li, B, Al, Ba, Sr, Zn, and the like.

If the content of the glass 24 in the second external electrode 22 is small, the adhesion of the second external electrode 22 to the multilayer chip 10 is insufficient and there is a risk of peeling. Therefore, it is preferable to set a lower limit for the content of the glass 24 in the second external electrode 22. On the other hand, if the content of the glass 24 in the second external electrode 22 is large, the bonding of the second external electrode 22 with the first external electrode 21 is insufficient and there is a risk of peeling. Therefore, it is preferable to set an upper limit for the content of the glass 24 in the second external electrode 22. For example, the content of the glass 24 in the second external electrode 22 is preferably 3 wt % or more and 18 wt % or less, more preferably 4 wt % or more and 12 wt % or less, even more preferably 5 wt % or more and 8 wt % or less with respect to the entire second external electrode 22.

Since the co-material is intended to delay the sintering of the metal component, glass, which is a sintering accelerator, is not used together in the same layer. Therefore, whether or not the first external electrode 21 is a co-fired external electrode can be determined by whether or not the co-material is included. On the other hand, since the second external electrode 22 contains glass, it is found to have been retrofitted by heat treatment at a relatively low temperature (for example, 1100° C. or lower). A pure metal film containing neither a co-material nor glass is a film formed by sputtering or the like, and therefore differs from the first external electrode 21 and the second external electrode 22 according to the present embodiment.

In the process of baking the second external electrode 22, the co-material 23 may diffuse into the second external electrode 22 and the glass 24 may diffuse into the first external electrode 21. In this case, the first external electrode 21 (first section) contains more co-material 23 and less glass 24 than the second external electrode 22. In the second external electrode 22 (second section), the content of the co-material 23 is less than that of the first external electrode 21, and the content of the glass 24 is greater than that of the first external electrode 21.

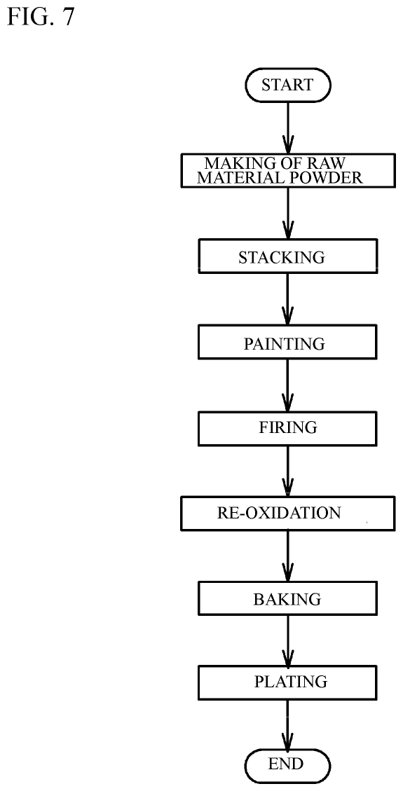

Next, a description will be given of a manufacturing method of the multilayer ceramic capacitors 100. FIG. 7 illustrates a manufacturing method of the multilayer ceramic capacitor 100.

(Making process of raw material powder) A dielectric material for forming the dielectric layer 11 is prepared. The dielectric material includes the main component ceramic of the dielectric layer 11. Generally, an A site element and a B site element are included in the dielectric layer 11 in a sintered phase of grains of ABO₃. For example, BaTiO₃ is tetragonal compound having a perovskite structure and has a high dielectric constant. Generally, BaTiO₃ is obtained by reacting a titanium material such as titanium dioxide with a barium material such as barium carbonate and synthesizing barium titanate. Various methods can be used as a synthesizing method of the ceramic structuring the dielectric layer 11. For example, a solid-phase method, a sol-gel method, a hydrothermal method or the like can be used. The embodiments may use any of these methods.

An additive compound may be added to the resulting ceramic powder, in accordance with purposes. The additive compound may be an oxide of Mg (magnesium), Mn (manganese), V (vanadium), Cr or a rare earth element (Y, Sm (samarium), Eu (europium), Gd (gadolinium), Tb (terbium), Dy (dysprosium), Ho (holmium), Er (erbium), Tm (thulium) and Yb (ytterbium)), or an oxide of Co (cobalt), Ni, Li (lithium), B (boron), Na (sodium), K (potassium) and Si (silicon). The additive compound may be a glass including cobalt, nickel, lithium, boron, sodium, potassium or silicon. Among them, SiO₂ mainly acts as a sintering agent.

For example, the resulting ceramic raw material powder is wet-blended with additives and is dried and crushed. Thus, a ceramic material is obtained. For example, the particle diameter may be adjusted by crushing the resulting ceramic material as needed. Alternatively, the grain diameter of the resulting ceramic power may be adjusted by combining the crushing and classifying. With the processes, a dielectric material is obtained.

(Stacking process) Next, a binder such as polyvinyl butyral (PVB) resin, an organic solvent such as ethanol or toluene, and a plasticizer are added to the resulting dielectric material and wet-blended. With use of the resulting slurry, a dielectric green sheet 52 is painted on a base material 51 by, for example, a die coater method or a doctor blade method, and then dried. The base material 51 is, for example, PET (polyethylene terephthalate) film.

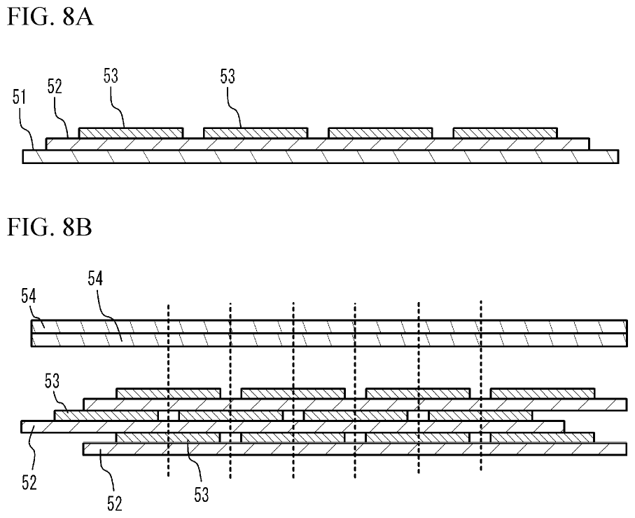

Next, as illustrated in FIG. 8A, an internal electrode pattern 53 is formed on the dielectric green sheet 52. In FIG. 8A, as an example, four parts of the internal electrode pattern 53 are formed on the dielectric green sheet 52 and are spaced from each other. The dielectric green sheet 52 on which the internal electrode pattern 53 is formed is a stack unit.

A metal paste of the main component metal of the internal electrode layer 12 is used for the internal electrode pattern 53. The film forming method may be printing, sputtering, vapor deposition or the like.

Next, the dielectric green sheets 52 are peeled from the base materials 51. As illustrated in FIG. 8B, the stack units are stacked.

A predetermined number (for example, 2 to 10) of a cover sheet 54 is stacked on an upper face and a lower face of a ceramic multilayer structure of the stacked stack units and is thermally crimped. The resulting ceramic multilayer structure is cut into a chip having a predetermined size (for example, 1.0 mm×0.5 mm). In FIG. 8B, the multilayer structure is cut along a dotted line. The components of the cover sheet 54 may be the same as those of the dielectric green sheet 52. Additives of the cover sheet 54 may be different from those of the dielectric green sheet 52.

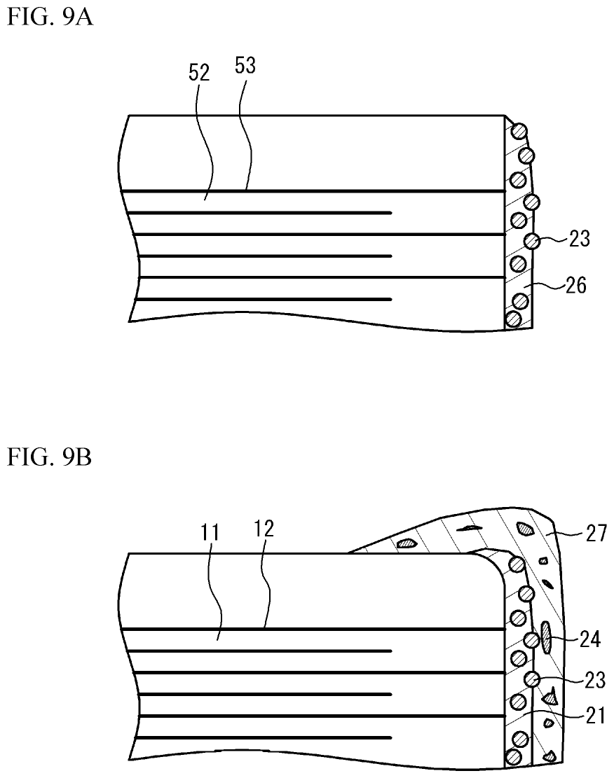

After the ceramic multilayer structure thus obtained is subjected to a binder removal treatment in an N₂ atmosphere, a metal paste 26 to be the first external electrodes 21 is applied by a dipping method or the like, as illustrated in FIG. 9A. The co-material 23 is included in the metal paste 26. For example, the metal paste 26 is applied to two end surfaces of the ceramic multilayer structure where the internal electrode patterns 53 are exposed.

(Firing process) The resulting ceramic multilayer structure is fired for 10 minutes to 2 hours in a reductive atmosphere having an oxygen partial pressure of 10⁻⁵ to 10⁻⁸ atm in a temperature range of 1100 degrees C. to 1300 degrees C. Thus, the multilayer chip 10 and the first external electrodes 21 are co-fired.

(Re-oxidizing process) After that, a re-oxidizing process may be performed in N₂ gas atmosphere in a temperature range of 600 degrees C. to 1000 degrees C.

(Baking process) Next, as exemplified in FIG. 9B, a metal paste 27 that will become the second external electrodes 22 is applied onto the first external electrodes 21 by a dipping method or the like. The metal paste 27 contains the glass 24. For example, the metal paste 27 is applied so as to extend to at least one of four surfaces other than the two end surfaces where the internal electrode layers 12 are exposed in the stack body. After that, the second external electrodes 22 are formed by baking the metal paste 27 at, for example, about 700 degrees C. to 900 degrees C.

(Plating process) After that, by a plating process, plated layers of Cu, Ni, Sn or the like may be formed on the second external electrodes 22.

According to the manufacturing method according to the present embodiment, since the second external electrodes 22 are formed in the process of simultaneously firing the multilayer chip 10 and the first external electrodes 21, only the first external electrodes 21 need not be thickly formed. Therefore, the stress during simultaneous firing of the first external electrodes 21 is relieved, and the occurrence of cracks can be suppressed. Further, since the first external electrode 21 is arranged between the second external electrode 22 and the multilayer chip 10, the diffusion of the glass 24 into the multilayer chip 10 is suppressed, and the occurrence of cracks is suppressed. Moreover, since the second external electrode 22 including the glass 24 can be baked at a low temperature (for example, about 800° C.), the occurrence of cracks is suppressed. In addition, since the main component of the first external electrode 21 and the main component of the second external electrode 22 are the same metal, a strong bonding can be obtained between the first external electrode 21 and the second external electrode 22, and stress can be reduced. And, interfacial peeling is suppressed. As described above, the external electrode 20b according to the present embodiment can suppress the occurrence of cracks. Since the external electrode 20a also has the same stacked structure as that of the external electrode 20b, the external electrode 20a can also be prevented from cracking.

In the embodiments, the multilayer ceramic capacitor is described as an example of ceramic electronic devices. However, the embodiments are not limited to the multilayer ceramic capacitor. For example, the embodiments may be applied to another electronic device such as varistor or thermistor.

### Examples

Hereinafter, the multilayer ceramic capacitor according to the embodiment was manufactured and its characteristics were investigated.

(Example) BaTiO₃ with an average particle diameter of 150 nm was used as the main raw material, and a small amount of Ho2O3, MgO, MnCO₃, and SiO₂ were added to form a powder mixture. The powder was dispersed in an organic solvent to form a slurry, a binder was added, and the slurry was coated on a PET film to a predetermined thickness. It was processed and dried to obtain a ceramic green sheet. An internal electrode paste of Ni was printed thereon to form an internal electrode pattern. After stacking 100 sheets of the obtained stack unit, the upper and lower sides were sandwiched by ceramic green sheets on which Ni was not printed, and the stack units were press-bonded. After press-bonding, it was cut into 3216-shaped small pieces and heat-treated (binder removal treatment) in an N₂ atmosphere. After that, a Ni metal paste (containing 10 wt % of BaTiO₃ powder) was formed by dipping on the two end faces of the small piece where the internal electrode layers were exposed, and then fired at 1250° C. in a mixed gas of N₂—H₂-H₂O. The amount of dipping at this time was adjusted so that the average thickness of the first external electrode after sintering would be 5 μm or less. A Ni metal paste (containing 20 wt % of Si—Li—Zn—O glass) was dipped into the fired sample. The amount of dipping was adjusted so that the extension distance of the dipping on the upper surface, the lower surface, and the two side surfaces were about 0.5 mm. The second external electrode was baked at 800° C. for 10 minutes in an N₂ atmosphere. After that, electrolytic plating of Cu, Ni and Sn in this order was performed on the second external electrode.

It was confirmed that the obtained multilayer ceramic capacitor had a structure in which the outside of the first external electrodes containing the co-material was covered with the second external electrodes containing glass but not containing the co-material. Specifically, 20 chips randomly selected from a large number of chips were embedded in resin and polished to prepare a sample with a cross section. All of them were confirmed to be the designed structures by using an optical microscope and a scanning electron microscope (SEM).

(Comparative example 1) In Comparative Example 1, only the first external electrode was thickly applied to a thickness of 30 μm, and the second external electrode was not formed. Other conditions were the same as in the example.

(Comparative example 2) In Comparative Example 2, the second external electrode was formed without forming the first external electrode. Other conditions were the same as in the example.

(analysis) For each of Example and Comparative Examples 1 and 2, 100 samples were mounted on a substrate and subjected to a mechanical stress test to confirm the presence or absence of cracks. Specifically, after reflow soldering to a glass epoxy substrate acting as a test substrate, a load was applied from the back side of the substrate at a pressure rate of 0.5 mm/sec with a fulcrum interval of 90 mm, and the substrate was bent to a deflection amount of 1 mm and held for 10 seconds, and the load was removed. The operation was defined as one cycle, and this was repeated 200 cycles. After that, heat was applied to the solder. And solder was removed from the board, and cracks were confirmed. Specifically, the presence or absence of cracks was confirmed by ultrasonic testing (SAT). Just to make sure, the contact interface between the internal electrode layer and the external electrode was confirmed by SEM, and it was confirmed that there was no reaction phase with glass and no alloying phase of the internal electrode. Table 1 shows the results.

TABLE 1

| | OCCURRENCE RATE OF CRACK |
|---|---|
| EXAMPLE | 0/100 |
| COMPARATIVE | 4/100 |
| EXAMPLE 1 | |
| COMPARATIVE | 65/100 |
| EXAMPLE 2 | |

In Comparative Example 1, it was confirmed by SAT or SEM that cracks occurred in 4 out of 100 samples. It is considered that this was because the thickness of the first external electrode had to be increased because the second external electrode was not formed. In Comparative Example 2, it was confirmed by SAT or SEM that cracks occurred in 65 out of 100 samples. It is considered that this is because the glass diffused into the multilayer chip because the first external electrode was not formed. On the other hand, it was confirmed that cracks did not occur in any of the samples in Example. It is considered that this was because the second external electrode containing glass and mainly composed of the same metal as the first external electrode was formed on the first external electrode containing a co-material, thereby eliminating the need to increase the thickness of the first external electrode, and the diffusion of the glass was also suppressed.

Although the embodiments of the present invention have been described in detail, it is to be understood that the various change, substitutions, and alterations could be made hereto without departing from the spirit and scope of the invention.

What is claimed is:

1. A multilayer ceramic electronic device comprising;
a multilayer chip having a plurality of internal electrode layers that face each other and a plurality of dielectric layers, each of which is sandwiched by two of the plurality of internal electrode layers, one end of at least one of the plurality of internal electrode layers being exposed at a side face of the multilayer chip, the side face being an end of the multilayer chip in a direction in which the plurality of internal electrode layers extend;
a first external electrode that is provided on the side face of the multilayer chip, is in contact with the exposed one end of the at least one of the plurality of internal electrode layers, and includes ceramic grains and
a second external electrode that is provided on the first external electrode, has a glass, and has a main component that is a same metal as that of the first external electrode.

2. The multilayer ceramic electronic device as claimed in claim 1, wherein the second external electrode is in contact with a main face of the multilayer chip and a corner portion of the multilayer chip, the main face being an end of the multilayer chip in a direction in which the plurality of dielectric layers and the plurality of internal electrode layers are stacked.

3. The multilayer ceramic electronic device as claimed in claim 1, wherein the plurality of internal electrode layers have a main component that is a same metal as that of the first external electrode.

4. The multilayer ceramic electronic device as claimed in claim 1, wherein the first external electrode and the second external electrode are in direct contact with each other.

5. The multilayer ceramic electronic device as claimed in claim 1, wherein each of the ceramic grains is a metal oxide.

6. The multilayer ceramic electronic device as claimed in claim 3,
wherein a main component of the plurality of internal electrode layers, the first external electrode, and the second external electrode is nickel, and
wherein each of the ceramic grains contains at least one of aluminum oxide or barium titanate.

7. The multilayer ceramic electronic device as claimed in claim 3,
wherein a main component of the plurality of internal electrode layers, the first external electrode, and the second external electrode is copper, and
wherein each of the ceramic grains contains at least one of aluminum oxide or calcium zirconate.

8. The multilayer ceramic electronic device as claimed in claim 1,
wherein, in the direction in which the plurality of internal electrode layers extend, a thickness of the first external electrode is 5 μm or less.

9. The multilayer ceramic electronic device as claimed in claim 1, wherein the ceramic grains are contained in an amount of 5 wt % or more and 20 wt % or less in the first external electrode.

10. The multilayer ceramic electronic device as claimed in claim 1 further comprising:
a plated layer on the second external electrode layer.

11. A multilayer ceramic electronic device comprising;
a multilayer chip having a plurality of internal electrode layers that face each other and a plurality of dielectric layers, each of which is sandwiched by two of the plurality of internal electrode layers, one end of at least one of the plurality of internal electrode layers being exposed at a side face of the multilayer chip, the side face being an end of the multilayer chip in a direction in which the plurality of internal electrode layers extend; and
an external electrode having a first section and a second section,
wherein the first section is provided on the side face of the multilayer chip, is in contact with the exposed one end of the at least one of the plurality of internal electrode layers, and includes ceramic grains,
wherein a second section covers the first section and includes glass,
wherein an amount of the ceramic grains of the first section is larger than that of the second section, and
wherein an amount of the glass of the second section is larger than that of the first section.

12. The multilayer ceramic electronic device as claimed in claim 11, wherein the second section is in contact with a main face of the multilayer chip and a corner portion of the multilayer chip, the main face being end of the multilayer chip in a direction in which the plurality of dielectric layers and the plurality of internal electrode layers are stacked.

13. The multilayer ceramic electronic device as claimed in claim 11, wherein the plurality of internal electrode layers have a main component that is a same metal as that of the external electrode.

14. The multilayer ceramic electronic device as claimed in claim 11, wherein each of the ceramic grains is a metal oxide.

15. The multilayer ceramic electronic device as claimed in claim 13,
wherein a main component of the plurality of internal electrode layers and the external electrode is nickel, and
wherein each of the ceramic grains contains at least one of aluminum oxide or barium titanate.

16. The multilayer ceramic electronic device as claimed in claim 13,
wherein a main component of the plurality of internal electrode layers and external electrode is copper, and
wherein each of the ceramic grains contains at least one of aluminum oxide or calcium zirconate.

17. The multilayer ceramic electronic device as claimed in claim 11 further comprising:
a plated layer on the external electrode layer.

18. A manufacturing method of a multilayer ceramic electronic device comprising:
forming a plurality of ceramic green sheets;
forming an internal electrode pattern of a conductive paste on at least some of the plurality of ceramic green sheets;
thereafter, forming an unfired multilayer chip by stacking the plurality of the green sheets,
forming a metal paste including ceramic grains on a side face of the unfired multilayer chip;
forming a first external electrode from the metal paste by firing the unfired multilayer chip and the metal paste; and
forming a second external electrode containing glass so as to cover the first external electrode after the firing.

19. The method as claimed in claim 18 further comprising:
forming a plated layer on the second external electrode.
